(19) United States
(12) Patent Application Publication
(10) Pub. No.: US 2006/0015531 A1
(43) Pub. Date: Jan. 19, 2006

(54) Device and system for digital signage

(76) Inventors: Moshe Fraind, Jerusalem (IL); Chaim Fleischer, Caesarea (IL)

Correspondence Address: NATH & ASSOCIATES, PLLC, Sixth Floor, 1030 15th Street, N.W., Washington, DC, 20005-1503, US

(21) Appl. No.: 10/893,555

(22) Filed: Jul. 19, 2004

(51) Int. Cl. G06F 17/00

(52) U.S. Cl. 707/104.1

(57) ABSTRACT

A device, system and method for digital signage. The device comprises an electronic display screen and a multimedia player. The multimedia player is configured to communicate with a portable storage device so as to allow downloading of one or more multimedia presentation files from the portable storage device to the multimedia player. The multimedia player is further configured to display on the display screen one or more of the multimedia files stored in the first memory. The system comprises one or more devices for digital signage of the invention. A programming station is configured to store one or more multimedia presentation files and to transfer one or more multimedia presentation files from the third memory to a portable storage device. The portable storage device is configured to download one or more multimedia presentations to a memory of one or more of the players. The method of the invention comprises transferring one or more multimedia presentation files from a programming station to a portable storage device, and subsequently downloading one or more multimedia presentation files from the portable storage device to a memory of a player. One or more multimedia files stored in the memory of the player are then displayed on an electronic display screen

### FIELD OF THE INVENTION

The present invention relates to methods and systems for digital signage.

### BACKGROUND OF THE INVENTION

The term “electronic signage” refers to the display of visual content on an electronic display screen for public viewing. The displayed visual content may be, for example, advertising or information to people in the vicinity of the display screen. In contrast to traditional billboards displaying printed matter, electronic signage allows display of animated or video sequences. Electronic signage also allows rapid changeover of the displayed contents. The rapid changeover of electronic signage also allows an electronic display screen to display, intermittently, several different visual content items over a time period. This prevents the boredom generated by traditional billboards once their visual content has been on display for a relatively short period of time.

U.S. Pat. No. 6,430,603 to Hunter discloses a system for placement of visual content on electronic displays. Advertisers send advertisements over the Internet to a server. The advertisements are then transmitted from the server over a communications network to one or more electronic displays. The communications network may be a high speed cable, a satellite communication system, a dedicated phone line, the Internet, a cellular phone system, or radio/radio pulse transmission.

### SUMMARY OF THE INVENTION

In its first aspect, the present invention provides a display device for digital signage. The display device includes an electronic display screen. The device further includes a PC-based player. The PC-based player is a multimedia player configured to play a multimedia format such a MPEG, 1/2/4, FLASH, JPEG and Power Point in a scheduled manner. The PC-player has a memory and is configured to display one or more multimedia presentations stored in its memory on the display screen. The player is also configured to receive one or more multimedia presentation files from a portable storage device, and to store multimedia presentation files downloaded from the portable storage device in the PC-player memory. Downloading of multimedia presentation files from the portable storage device to the PC-memory may be by means of a wired or a wireless connection. The display device of the invention is not configured to be connected to a communications network.

In its second aspect, the invention provides a system for digital signage. In accordance with this aspect of the invention, the system includes one or more display devices for digital signage of the invention. The system also includes a programming station that may be, for example, a personal computer. The programming station includes a processor configured to run a computer program for designing one or more multimedia presentations (referred to herein as “clips”) for display on a display device of the system. A clip designed at the programming station may be stored in a memory associated with the processor.

The system also includes a portable storage device having a processor and a memory. The processor of the portable storage device and the programming station processor are configured to allow one or more clips designed at the programming station to be transferred from the programming station processor to the memory of the portable storage device. Together with each clip, auxiliary information relating to the clip may also be transferred from the programming station processor and the memory of the portable storage device. Such auxiliary information may include, for example, the display devices in the system in which the clip is to be displayed or the precise times at which it is to be displayed on each specific display device (scheduling). A clip, together with any auxiliary information, may be transferred from the programming station to the portable storage device over a wired or wireless connection.

It is also possible to send the programming products (i.e. the clip/s and the playlist) to a remote PC and there to be downloaded to the portable device After one or more clips have been stored in the portable storage device memory, the portable storage device is brought into proximity with one of the digital signage devices of the system. One or more clips, possibly with auxiliary information relating to the clips, are then downloaded from the memory of the portable storage device to the memory of the PC-player.

In its third aspect, the invention provides a fixture having an integrated device for digital signage in accordance with the invention. The fixture may be, for example, a billboard or a sales rack. The fixture does not need to be connected by a wired connection to a communication network.

Thus, in accordance with one of its aspects, the invention provides a device for digital signage comprising:
(a) an electronic display screen;
(b) a player having a first memory, configured to:
   (i) communicate with a portable storage device having a second memory, so as to download one or more multimedia presentation files from the second memory to the first memory; and
   (ii) display on the display screen one or more multimedia files stored in the first memory.

In another of its aspects, the invention provides a system for digital signage comprising:
(a) one or more devices for digital signage according to the invention;
(b) a programming station having a third memory configured to store one or more multimedia presentation files and to communicate with a portable storage device having a second memory, so as to transfer one or more multimedia presentation files from the third memory to the second memory; and
(c) one or more portable storage devices, each portable storage device having a second memory, each portable storage device being configured to
   (i) receive one or more multimedia presentation files stored in the third memory and store the one or more multimedia presentation files in the second memory; and
   (ii) download one or more multimedia presentations stored in the second memory to a first memory of one or more of the players.

In yet another of its aspects, the invention provides a method for digital signage comprising:
(a) transferring one or more multimedia presentation files from a third memory of a programming station to a second memory of a portable storage device; and
(b) downloading one or more multimedia presentation files stored in the second memory of the portable storage device to a first memory of a player, and
(c) displaying on an electronic display screen one or more multimedia files stored in the first memory.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows a display device for digital signage in accordance with one aspect of the invention;

FIG. 2 shows a system for digital signage in accordance with another aspect of the invention;

FIG. 3 shows downloading of an multimedia presentation to a display device for digital signage of the invention;

FIG. 4 shows a billboard having an integrated device for digital signage in accordance with the invention; and

FIG. 5 shows a sales rack having an integrated device for digital signage in accordance with the invention.

### DETAILED DESCRIPTION OF THE INVENTION

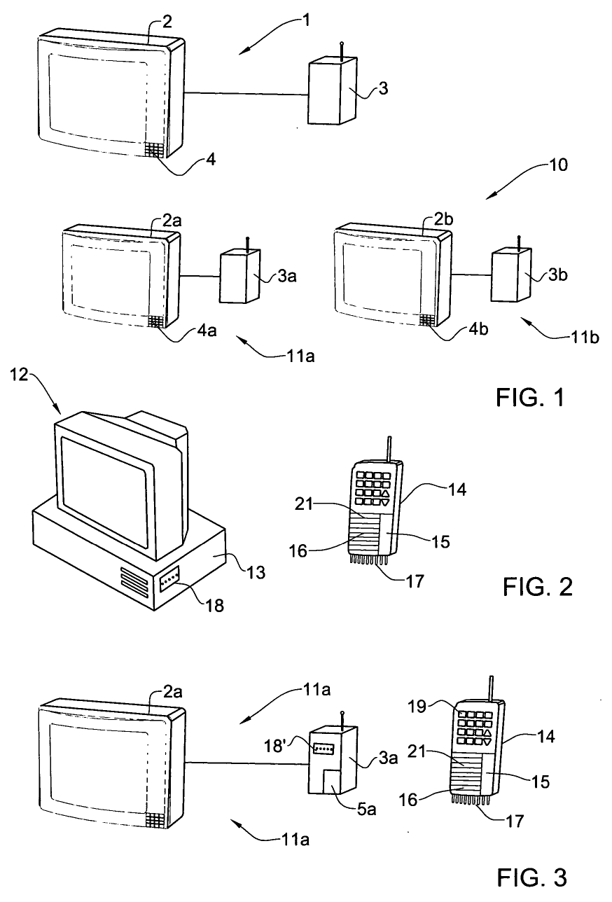

FIG. 1 shows a display device 1 for digital signage in accordance with one embodiment of the invention. The display device 1 includes an electronic display screen 2 that may be, for example, a plasma screen. The screen 2 has one or more associated sound speakers 4. The device 1 further includes a PC-based player 3. The player 3 is a multimedia player configured to play a multimedia format such a MPEG, 1/2/4, FLASH, JPEG and Power Point in a scheduled manner. The player 3 has a memory 5 and is configured to display one or more multimedia presentations stored in the memory 5 on the display screen 2. The player 3 is further configured to receive one or more multimedia presentation files from a portable storage device, as described below.

FIG. 2 shows a system 10 for digital signage in accordance with one embodiment of this aspect of the invention. The system 10 includes one or more display devices 11 for digital signage of the invention. In the system 10, two devices for digital signage, 11a and 11b are shown. This is by way of example only, and the system of the invention may be implemented with any number of devices 11 for digital signage of the invention.

As described above in reference to FIG. 1, the devices 11a and 11b include an electronic display screen 2a and 2b, respectively, and a PC based player 3a and 3b, respectively. The display screens 2a and 2b include a speaker 4a and 4b, respectively. The PC-players 3a and 3b are multimedia players configured to play a multimedia format such a MPEG, 1/2/4, FLASH, JPEG and Power Point in a scheduled manner. The PC-players 3a and 3b have a memory 5a and 5b, respectively, and are configured to display one or more multimedia presentations stored in its memory on the display screen 2a and 2b, respectively.

The system 10 further includes a programming station 12 that may be a personal computer. The programming station 12 includes a processor 13 having an associated memory for storing one or more clips to be displayed on one or more of the display devices 11. The programming station 12 may be configured to run a computer program for designing one or more clips to be displayed on one or more of the display devices 11. A clip designed at the programming station may be stored in the memory associated with the process 13.

The system 10 also includes one or more portable storage devices 14. Each portable storage device 14 includes a processor 15 and a memory 16. The processor 13 of the programming station 12 and the processor 15 of the portable storage device 14 are configured to allow one or more clips stored in the memory of the programming station 12 to be transferred from the programming station processor 13 to the memory 16 of the portable storage device processor 15. Each clip may be transferred from the programming station processor 13 to the memory 16 of the portable storage device processor 15 together with auxiliary information relating to the clip. A clip may be transferred from the processor 13 to the processor 15 over a wired connection. In a preferred embodiment, the portable storage device 14 may be provided with a plug 17 configured to be inserted into a mated socket 18 on the processor 13, for transferring clips from the programming station memory to the memory 16 of the portable storage device. Alternatively, clips from the programming station 12 may be transferred to the portable storage device 14 over a wireless connection. Each clip transferred from the processor 13 to the processor 15 is stored in a separate entry 21 in the memory 16. Alternatively, the programming products may be sent to a remote station such as a PC, for example, as an e-mail attachment or using FTP. The remote PC does not need to run the programming software. The portable storage device (PDA) can then be uploaded from the remote PC.

As shown in FIG. 3, after one or more clips have been stored in the memory 16, the portable storage device 14 is brought into proximity with one of the digital signage devices 11 of the invention, such as the digital signage device 11a. The one or more clips that are to be downloaded onto the memory 5a of the player 3a are then downloaded onto the memory of the player 3a together with the play-list that contains the scheduling program for the player 3a. This may be carried out, for example, by inputting a numerical code identifying each player to a keypad 19 in order to download the dedicated pre programmed play-list and clips for this player. The processor then transmits the clip, together with auxiliary information relating to the clip, to the memory 5a. Alternatively, a numerical code identifying the display device 11a may be input to the keypad 19, and the clips to be downloaded to this display device are then downloaded to the memory 5a of the PC-player 3a.

Downloading of a clip from the memory 16, of the portable program storage device 14 to the memory 5a of the PC-based player 3a may be via a wireless connection. Alternatively, the PC-based player 3a of the digital display device 11a may be provided with a socket 18′ to receive the plug 17 of the portable storage device 14 for downloading clips to the memory 5a, as shown in FIG. 3.

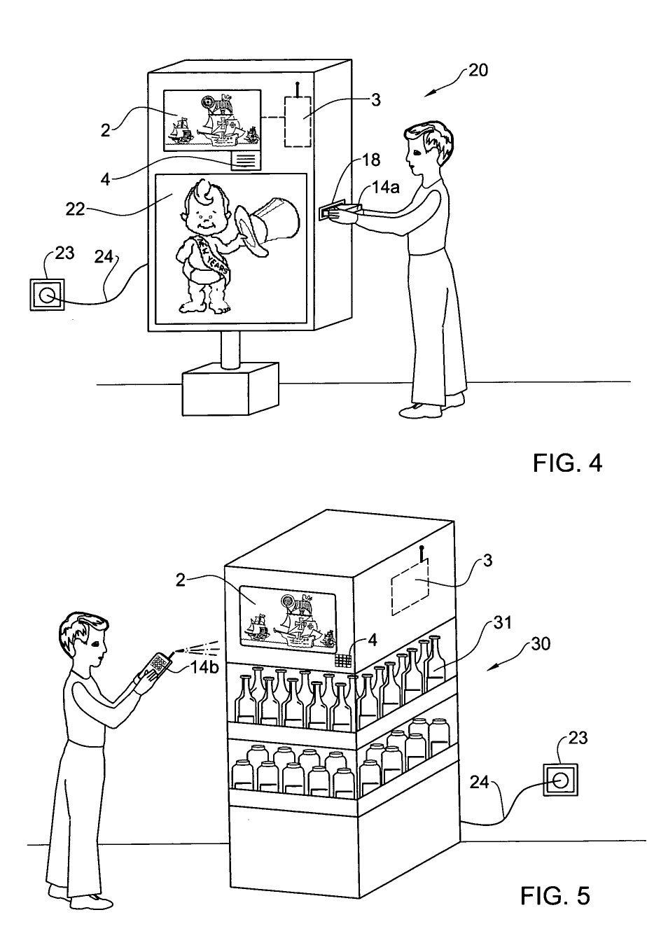

The display device 1 may be integrated into a fixture. For example, FIG. 4 shows a billboard 20 having an integrated device 1 for digital signage in accordance with the invention. The display screen 2 and associated sound speaker 4 are exposed on the surface of the billboard 20, while the player 3 is concealed in an interior chamber of the billboard 20. The billboard is designed to display printed matter such as a poster 22. Power for the device 1 is provided from an electrical socket 23 via an electric cable 24. The billboard 20 does not need to be connected by a wired connection to a communication network. In FIG. 4, communication between a portable storage device 14a and the player 3 is established by inserting the portable storage device 14a into a socket 18 located on the surface of the billboard. The player 3 is programmed from the portable storage device 14, as described above.

FIG. 5 shows a sales rack 30 having an integrated display device 1 for digital signage in accordance with the invention. The display screen 2 and associated sound speaker 4 are exposed on the surface of the sales rack 30, while the player 3 is concealed in an interior chamber of the sales rack 30. The sales rack 30 is designed to display items 31 for sale. Power for the device 1 is provided from an electrical socket 23 via an electric cable 24. The sales rack 30 does not need to be connected by a wired connection to a communication network. In FIG. 5, communication between a portable storage device 14b and the sales rack 30 is by means of a wireless communication link 28 and a receiver associated with the player (not shown). The player 3 is programmed from the portable storage device 14, as described above.

1. A device for digital signage comprising:
(a) an electronic display screen;
(b) a player having a first memory, configured to:
(i) communicate with a portable storage device having a second memory, so as to download one or more multimedia presentation files from the second memory to the first memory; and
(ii) display on the display screen one or more multimedia files stored in the first memory.

2. A system for digital signage comprising:
(a) one or more devices for digital signage according to claim 1;
(b) a programming station having a third memory configured to store one or more multimedia presentation files and to communicate with a portable storage device having a second memory, so as to transfer one or more multimedia presentation files from the third memory to the second memory; and
(c) one or more portable storage devices, each portable storage device having a second memory, each portable storage device being configured to:
(i) receive one or more multimedia presentation files stored in the third memory and store the one or more multimedia presentation files in the second memory; and
(ii) download one or more multimedia presentations stored in the second memory to a first memory of one or more of the players.

3. The system according to claim 2 wherein the programming station and the portable storage device are configured so as to allow a multimedia file to be transferred from the third memory to the second memory over a wired connection.

4. The system according to claim 3 wherein the portable storage device is provided with a plug configured to be inserted into a mated socket on the programming station and transferring a multimedia file from the third memory to the second memory involves inserting the plug into the socket.

5. The system according to claim 2 wherein the programming station and the portable storage device are configured so as to allow a multimedia file to be transferred from the third memory to the second memory over a wireless connection.

6. The system according to claim 2 wherein the portable storage device and the player are configured so as to allow a multimedia file to be transferred from the second memory to the first memory over a wired connection.

7. The system according to claim 6 wherein the portable storage device is provided with a plug configured to be inserted into a mated socket on the player and transferring a multimedia file from the second memory to the first memory involves inserting the plug into the socket.

8. The system according to claim 2 wherein the portable storage device and the player are configured so as to allow a multimedia file to be transferred from the second memory to the first memory over a wireless connection.

9. The system according to claim 1 wherein the programming station and the portable storage device are further configured to allow auxiliary information relating to a multimedia presentation file to be transferred from the programming station to the portable storage device.

10. The system according to claim 1 wherein the portable storage device and the player are further configured to allow auxiliary information relating to a multimedia presentation file to be transferred from the portable storage device to the player.

11. A fixture comprising the device for electronic signage according to claim 1.

12. The fixture according to claim 11 being a billboard or a sales rack.

13. A method for digital signage comprising:
(a) transferring one or more multimedia presentation files from a third memory of a programming station to a second memory of a portable storage device; and
(b) downloading one or more multimedia presentation files stored in the second memory of the portable storage device to a first memory of a player, and
(c) displaying on an electronic display screen one or more multimedia files stored in the first memory.

14. The method according to claim 13 wherein a multimedia file is transferred from the third memory to the second memory over a wired connection.

15. The method according to claim 14 wherein the portable storage device is provided with a plug configured to be inserted into a mated socket on the programming station and transferring a multimedia file from the third memory to the second memory involves inserting the plug into the socket.

16. The method according to claim 13 wherein a multimedia file is transferred from the third memory to the second memory over a wireless connection.

17. The method according to claim 13 wherein a multimedia file is transferred from the second memory to the first memory over a wired connection.

18. The method according to claim 17 wherein the portable storage device is provided with a plug configured to be inserted into a mated socket on the player and transferring a multimedia file from the second memory to the first memory involves inserting the plug into the socket.

19. The method according to claim 13 wherein multimedia file is transferred from the second memory to the first memory over a wireless connection.

20. The method according to claim 13 wherein the electronic display screen is integrated in a fixture.

21. The method according to claim 20 wherein the fixture is a billboard or a sales rack.
